(19) United States
(12) Patent Application Publication
(10) Pub. No.: US 2006/0229398 A1
(43) Pub. Date: Oct. 12, 2006

(54) Method for producing stable fluorine-containing water-dispersible latexes

(76) Inventor: Marek W. Urban, Hattiesburg, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/384,871

(22) Filed: Mar. 20, 2006

Related U.S. Application Data
(60) Provisional application No. 60/665,335, filed on Mar. 24, 2005.
(60) Provisional application No. 60/711,437, filed on Aug. 24, 2005.

(51) Int. Cl. C08K 3/30

(52) U.S. Cl. 524/423; 524/544; 524/556

(57) ABSTRACT

A process is disclosed for making stable colloidal dispersions (latexes) that form polymeric films containing fluoro-monomers such as heptadecafluorodecyl methacrylate (FMA), heptadecafluorodecyl acrylate (FA), heptadecafluoro-1-decene (FD), heptafluorobutyl acrylate (FBA), and heptafluorobutyl methacrylate (FBMA). The process involves use of a surfactant system containing a fluorocarbon-containing phosphoric acid ester salt such as phosphoric acid bis(tridecafluorooctyl) ester ammonium salt and an anionic alkyl sulfate such as sodium dodecyl sulfate. The combination of polymerization conditions and surfactant system facilitates a suitable environment for the aqueous copolymerization of the fluoro-monomer with one or more co-monomers in the acrylate and/or methacrylate families, such as n-butyl acrylate and methyl methacrylate.

This application claims the benefit of Provisional Applications Ser. No. 60/665,335 filed Mar. 24, 2005 and Ser. No. 60/711,437 filed Aug. 24, 2005.

The United States government has a paid-up license in this invention and the right in limited circumstances to require the patent owner to license others on reasonable terms as provided for the terms of contract numbers DMR0213883 and DMR EEC 0002775 awarded by the National Science Foundation.

### BACKGROUND OF THE INVENTION

The incorporation of fluorine-containing monomers into polymeric systems has been of considerable interest for a number of years due to the fact that their presence may introduce a number of unique physical and chemical properties. While such properties as thermal stability and chemical resistance are expected to be enhanced, decreases in surface tension and friction are consequences resulting from the presence of fluorine-containing species. However, exceptionally reduced surface tension and solubility in aqueous environments makes synthetic efforts quite challenging.

Although there are obvious advantages and benefits in generating fluorine-containing polymers via emulsion polymerization, their incorporation into colloidal particles is not straightforward. The primary reason is the immiscibility between hydrophobic C-F entities and the continuous aqueous phase resulting from large surface tension differences. Due to the fact that emulsion polymerization relies on the diffusion of monomers from monomer droplets through the aqueous phase to micelles for polymerization to occur, this process is severely limited, thus colloidal particles with only minor concentration levels of fluorine-containing species have been generated. Several synthetic attempts have been made to produce fluorine-containing colloidal dispersions in which organic solvents, high shear rates, homogenizers, fluorinated surfactants, and sonication techniques were utilized to facilitate monomer diffusion through an aqueous phase. Although these approaches have been somewhat successful, their preparation can be quite elaborate even with relatively low fluorine-content, thus inhibiting desirable film properties. Another approach to increase the fluorine-content of colloidal dispersions was to incorporate fluorine -containing acrylates into colloidal particles. The presence of the pendant —CF₃ end groups on the perfluoroalkyl side chains appear to generate even lower surface tensions than corresponding polytetrafluoroethylene (—CF₂—) polymers and their derivatives.

### SUMMARY OF THE INVENTION

The present invention provides a process for making stable colloidal dispersions (latexes) that form polymeric films containing fluoro-monomers such as heptadecafluorodecyl methacrylate (FMA), heptadecafluorodecyl acrylate (FA), heptadecafluoro-1-decene (FD), heptafluorobutyl acrylate (FBA), and heptafluorobutyl methacrylate (FBMA). The process involves use of a surfactant system containing a fluorocarbon-containing surfactant, preferably a fluorocarbon containing phosphoric acid ester salt such as phosphoric acid bis(tridecafluorooctyl) ester ammonium salt (FSP). The surfactant system desirably includes an anionic alkyl sulfate surfactant such as sodium dodecyl sulfate (SDS). The combination of polymerization conditions and surfactant system facilitates a suitable environment for the aqueous copolymerization of the fluoro-monomer with one or more co-monomers in the acrylate and/or methacrylate families, such as n-butyl acrylate and methyl methacrylate. The resulting colloidal particle morphologies consisted of two distinct phases, where MMA and nBA randomly polymerized forming spherical particles after which FMA polymerized onto the exterior of p-MMA/nBA colloidal particles generating non-spherical morphologies. The unique aspect of this approach was that the synthesis of colloidal particles containing fluoropolymers was accomplished using a classical emulsion polymerization approach without complex reaction setups, co-solvents, or other accessories.

### BRIEF DESCRIPTION OF THE DRAWINGS

FIGS. 1A, B and C are transmission electron micrographs of (A) MMA/nBA, (B) MMA/nBA/FMA(8.5% w/w of FMA), and (C) MMA/nBA/FMA (15% w/w of FMA) particles.

FIG. 2. Kinetic coefficient of friction plotted as a function of colloidal composition. The same γ-axis is also used to plot contact angle measurements (values should be multiplied by 1000).

FIG. 3. AFM phase images of copolymer films: A—MMA/nBA, B—MMA/nBA/FMA, C—MMA/nBA/FA, D—MMA/nBA/FD, E—MMA/nBA/FBMA, and F—MMA/nBA/FBA. Scan box for each image is 5 μm×5 μm.

### DETAILED DESCRIPTION OF PREFERRED EMBODIMENTS

The synthesis of F-containing colloidal dispersions may be troublesome because water-monomer miscibility in the presence of a fluorine-containing monomer is low due to the hydrophobic nature of the fluorinated species. In order to overcome these difficulties a simple synthetic procedure was developed in a first embodiment of the invention that allows the incorporation of fluorine-containing monomers into MMA/nBA copolymer particles by utilizing a fluorocarbon containing surfactant, such as SDS/FSP surfactant mixture. This approach facilitates the reduction of the surface tension of the aqueous phase, thus increasing the ability of the fluorine -containing monomer to diffuse into micelles. For example, the addition of 0.98% SDS (w/w aqueous solution) decreases the surface tension of the aqueous phase from 73 mN/m to 38 mN/m, and polymerization reactions conducted under these conditions in the presence of FMA generate colloidal dispersions containing a large degree of coagulum. On the other hand, the addition of SDS along with FSP (0.98% and 0.62% w/w aqueous solution, respectively) further reduces the surface tension of the aqueous phase to 19 mN/m. These conditions, as described in the Examples, provide a suitable environment for the synthesis of MMA/nBA/FMA copolymer particles containing up to 8.5% (w/w) FMA monomer.

Short and long chain fluorinated acrylates can be used as the fluorine-containing monomers, including without limitation: heptadecafluorodecyl methacrylate (FMA), heptadecafluorodecyl acrylate (FA), heptadecafluoro-1-decene (FD), heptafluorobutyl acrylate (FBA), and heptafluorobutyl methacrylate (FBMA). Almost any film forming monomers can be used if one wants to make films. While the preferred fluorocarbon containing surfactant is a phosphoric acid ester fluorocarbon, any fluorinated surfactant is useful. In particular, the ZONYL brand fluorosurfactants sold by DuPont are especially preferred.

In a second embodiment of the invention, p-methyl methacrylate/n-butyl acrylate/heptadecafluorodecyl methacrylate (p-MMA/nBA/FMA) colloidal dispersions containing up to 15% w/w of FMA were produced by utilization of biologically active phospholipids (PLs) in combination with ionic surfactants. The surfactants were 1,2-dilauroyl-sn-glycero-3-phosphocholine (DLPC), sodium dodecyl sulfate (SDS) and phosphoric acid bis (tridecafluoro-octyl) ester ammonium salt (FSP), these surfactants function as transfer and dispersing agents, facilitate a suitable environment for polymerization of p-MMA/nBA/FMA colloidal dispersions that exhibit non-spherical particle morphologies. Such non-spherical particles upon coalescence form phase-separated films with unique surface properties.

### EXAMPLE 1

T Methyl methacrylate (MMA), n-butyl acrylate (nBA), heptadecafluorodecyl methacrylate (FMA), potassium persulfate (KPS), and sodium dodecyl sulfate (SDS) were all purchased from Aldrich Chemical Co. Phosphoric acid bis(tridecafluoro-octyl) ester ammonium salt (FSP), was received from DuPont. The structures of SDS and FSP surfactants are shown below.

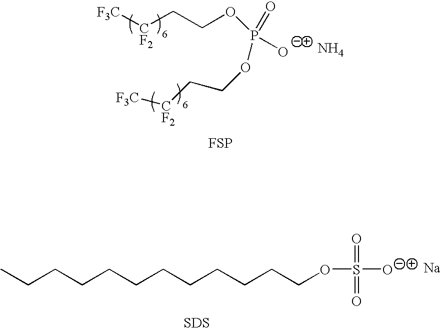

All colloidal dispersions were synthesized under monomer-starved conditions using a semi-continuous polymerization process in which all monomer and surfactants were dissolved in water and stirred under high agitation to produce a semi-stable pre-emulsion. 10% (w/w) of the pre-emulsion and 18% (w/w) of the initiator solution potassium persulfate were injected into the reaction kettle which contained 100 g of water. This process facilitates the seeding of the emulsion polymerization. The mixture was then stirred for 30 minutes to allow for initiation reactions to occur. The remaining pre-emulsion was fed continuously over 3.5 hr and the initiator solution was fed over 4 hr. Upon the completion of the initiator feed, polymerization was allowed to continue for an additional 5 hr. Polymerization reaction was carried out in a 1 L reaction kettle equipped with a reflux condenser at 79° C. in a N₂ atmosphere under continuous agitation (300 rpm) using a Caframo BDC3030 digital stirrer. Particle size measurements were obtained using a Microtrac UPA 250, and Table 1 lists the resulting particle sizes, % solids (w/w), and concentration levels of individual components.

TABLE 1
Colloidal Dispersion Compositions

| Specimens | A | B | C | D | E |
|---|---|---|---|---|---|
| FMA (w/w %) | 0 | 0 | 1.22 | 1.94 | 3.27 |
| MMA (w/w %) | 18.9 | 18.9 | 18.3 | 18.8 | 18.1 |
| nBA (w/w %) | 18.3 | 18.3 | 17.7 | 18.1 | 17.4 |
| SDS (w/w %) | 0.61 | 0.61 | 0.61 | 0.60 | 0.60 |
| FSP (w/w %) | 0 | 0.97 | 0.97 | 0.95 | 0.95 |
| KPS (w/w %) | 0.23 | 0.23 | 0.23 | 0.22 | 0.22 |
| DDI (w/w %) | 61.96 | 60.96 | 60.97 | 59.39 | 59.46 |
| Particle Size (nm) | 91 | 94 | 97 | 102 | 104 |
| % Solids | 45 | 42 | 41 | 43 | 42 |

As listed, specimen A represents MMA/nBA colloidal dispersions prepared in the presence of SDS, specimen B is MMA/nBA prepared using SDS/FSP surfactants. The same SDS/FSP mixture was used to prepare specimens C, D, and E which contain 3.3, 5, and 8.5% w/w FMA copolymer content, respectively. Such prepared colloidal dispersions were cast on a polyvinylchloride (PVC) substrate and allowed to coalescence at 50% relative humidity (RH) for 3 days at 23° C. to form approximately 20 μm thick films. Film thickness was determined by using a Pro Max caliper.

Polarized attenuated total reflectance Fourier transform infrared (ATR FTIR) spectra were collected using a Bio-Rad FTS-6000 FTIR single-beam spectrometer set at a 4 cm⁻¹ resolution which was equipped with a ZnSe polarizer. A 45° face angle Ge crystal with 50×20×3 mm was used. The use of a ZnSe polarizer facilitates orientation studies by utilizing TE (transverse electric) and TM (transverse magnetic) modes of polarized IR light. Each spectrum represents 100 co-added scans ratioed against the same number of reference scans collected using an empty ATR cell. All spectra were corrected for spectral distortions and optical effects using Q-ATR software.

Transmission electron micrographs (TEM) were acquired on a Zeiss EM 109T microscope using an accelerating voltage of 80 kV. Samples of colloidal dispersion used for TEM analysis were prepared by making a 1:10,000 dilution in deionized water followed by casting onto Formvar coated copper grids (Ted Pella, Inc.). Particle size and particle size distribution measurements were performed using a Microtrac UPA 250.

Surface tension measurements of polymeric films and solutions were conducted by using a FTA200 Dynamic Contact Angle Analyzer and a KRUSS Process Tensiometer K12, respectively. A Qualitest 1055 friction tester was utilized to determine the kinetic coefficient of friction, and each film was subjected to MEK double rubs to determine solvent resiliency.

### EXAMPLE 2

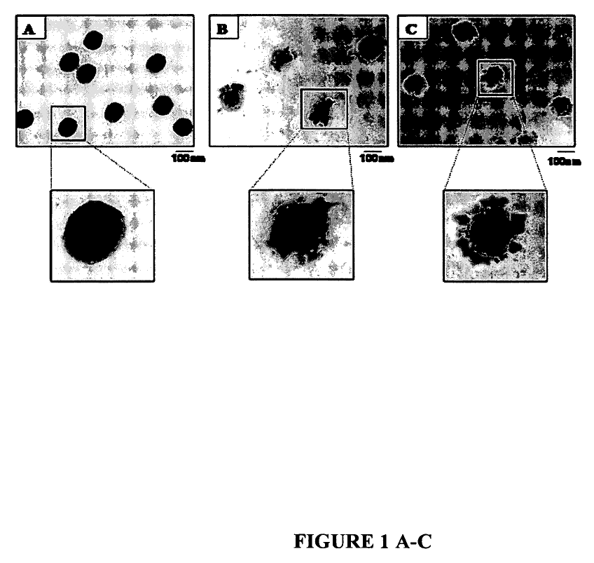

FIGS. 1, A, B, and C illustrates transmission electron microscopy (TEM) micrographs of a series of p-MMA/nBA, P-MMA/nBA/FMA (FMA 8.5% w/w) and P-MMA/nBA/FMA (FMA 15% w/w) colloidal particles, respectively. As seen, p-MMA/nBA particles are spherical, whereas p-MMA/nBA/FMA exhibit more complex morphologies. As shown in FIG. 1, B, p-MMA/nBA/FMA particles 8.5% w/w FMA) are non-spherical with the high electron density areas due to p-FMA phase forming non-uniform shell around the p-MMA/nBA core. As the FMA content increases to 15% w/w, and DLPC phospholipids was utilized, the size of p-FMA phase attached to the exterior of the particles increase, giving multi-lobe morphologies. This is illustrated in FIG. 1, C.

The combination of DLPC with SDS/FSP surfactants results in the reduction of the overall surface tension of the aqueous phase from 72 mN/m to about 1-5 mN/m. These conditions appear to be essential during polymerization of the F-containing colloidal particles because lower surface tension facilitates not only efficient monomer transport to the polymerization loci, but also provides stability of colloidal parties after synthesis.

As shown in Table 2, monodispersed particles are produced when DLPC and SDS/FSP surfactants are utilized. It is believed that this is attributed to similarities of head groups of DLPC and FSP and hydrophobic tails of SDS and DLPC. When monomers diffuse through an aqueous phase to the nucleation site, the reduced surface tension and monomer starvation conditions facilitate transport of higher quantities and polymerization of FMA into p-MMA/nBA particles. As MMA and nBA monomers initially migrate to the polymerization site, and upon initiation polymerize at the reactive site, monomer starvation conditions force FMA to migrate to the reactive site and diffuse to p-MMA/nBA copolymer core, which is facilitated by the present of PL which lowers the surface tension such that colloidal particles containing hydrophobic-lipophobic entities of p-FMA are stable and thus do not coagulate. Particle size measurements during polymerization indicate that the increase of the particle size is significant at the initial states, whereas at later stages is much slower. This behavior is attributed to faster MMA/nBA polymerization at the early stages, followed by slower polymerization, which requires migration of FMA to the reactive site at the later stages.

TABLE 2
Composition and particle size analysis of colloidal dispersions

| | | (B) | (C) |
|---|---|---|---|
| | (A) | MMA/nBA/ | MMA/nBA/ |
| | MMA/nBA | FMA(8.5%) | FMA(15%) |
| FMA (% w/w) | 0 | 3.3 | 5.8 |
| nBA (% w/w) | 18.9 | 17.33 | 16.1 |
| MMA (% w/w) | 19.7 | 18.04 | 16.73 |
| SDS (% w/w) | 0.91 | 0.91 | 0.91 |
| FSP (% w/w) | 0.58 | 0.58 | 0.58 |
| DLPC (% w/w) | 0.05 | 0.05 | 0.19 |
| KPS (% w/w) | 0.23 | 0.23 | 0.23 |
| DDI (% w/w) | 59.5 | 59.5 | 59.5 |
| Particle Size | 110 | 124 | 150 |
| (nm) | | | |
| % Solids | 40.5 | 40.5 | 40.5 |

The following materials, MMA, nBA, FMA, potassium persulfate (KPS), FSP, and SDS were purchased from Aldrich Chemical Co. DLPC phospholipids was purchased from Avanti Polar Lipids, Inc. p-MMA/nBA/FMA emulsions were synthesized using a semicontinuous process and adapted for small-scale polymerization. The reaction flask was placed in a water bath set at 78° C. and purged using N₂ gas. The reaction flask was charged with 20 ml of DDI water and while purging for 1 hour, the content was stirred at 300 rpm. At this point all monomers and surfactants were dissolved in water and stirred under high agitation to produce a semi-stable pre-emulsion. After which, 10% (w/w) of the pre-emulsion and 18% (w/w) of the initiator solution was injected into the reaction kettle thus facilitating the seeding of the emulsion polymerization. The remaining pre-emulsion was fed continuously over 4 hours while the initiator solution was fed over 4.5 hours. Upon the completion of initiator feed, polymerization was allowed to continue for another 4 hours. The amount of fluorine monomer incorporated into colloidal particles was determined from the initial feed composition of the initiator monomer mixture combined with the analysis of the solid content after the synthesis. Particle size measurements were obtained using a Microtrac UPA 250, and Table 2 lists the resulting particle sizes, % solids (% w/w) based on both the initial feed as well as solid content analysis after polymerization, and concentration levels of individual components for p-MMA/nBA (A), p-MMA/nBA/FMA (8.5% w/w FMA) (B), and p-MMA/nBA/FMA (15% w/w FMA) (C). It should be noted that Table 2 lists the w/w% of each composition utilized in the synthesis, and the % w/w of FMA listed above represents the FMA content with respect to MMA and nBA monomers. Such prepared colloidal dispersions were cast on a poly(vinyl chloride) PVC) substrate and allowed to coalescence at 50% relative humidity (RH) for 3 days at 23° C. to form approximately 20 μm thick films.

### EXAMPLE 3

This example focuses on the development of colloidal particles containing methyl methacrylate (MMA), n-butyl acrylate (nBA), and a series of F-monomers. Specifically, the affect of the length of the CF₂ tail on particle morphologies is studied as well as its effect on film formation, structure-property relationships, and surface macroscopic properties. For this experiment, we prepared methyl methacrylate/n-butyl acrylate (MMA/nBA) colloidal dispersions in the presence of 8.5% (w/w) copolymer content of heptadecafluorodecyl methacrylate (FMA), heptadecafluorodecyl acrylate (FA), heptadecafluoro-1-decene (FD), heptafluorobutyl acrylate (FBA), and heptafluorobutyl methacrylate (FBMA).

Methyl methacrylate (MMA), n-butyl acrylate (nBA), heptadecafluorodecyl methacrylate (FMA), heptadecafluorodecyl acrylate (FA), heptadecafluoro-1-decene (FD), heptafluorobutyl acrylate (FBA), heptafluorobutyl methacrylate (FBMA), potassium persulfate (KPS), phosphoric acid bis(tridecafluoro-octyl) ester ammonium salt (FSP), and sodium dodecyl sulfate (SDS) were purchased from Aldrich Chemical Co. All colloidal dispersions were synthesized as described in Example 1. Such prepared colloidal dispersions were cast on a polyvinylchloride (PVC) substrate and allowed to coalescence at 50% relative humidity (RH) for 3 days at 23° C. to form approximately 20 μm thick dry films. Film thickness was determined using a Pro Max caliper.

The synthesized colloidal particles consisted of MMA, nBA, and the following F-containing monomers: FMA, FA, FD, FBMA, and FBA. The copolymer content of each F-containing monomer in the colloidal particles was 8.5% (w/w). The amount of F-monomer incorporated into colloidal particles was determined from the initial feed composition of the initial monomer mixture combined with the analysis of the solid content after synthesis.

Below are illustrated the structure of each F-containing monomer.

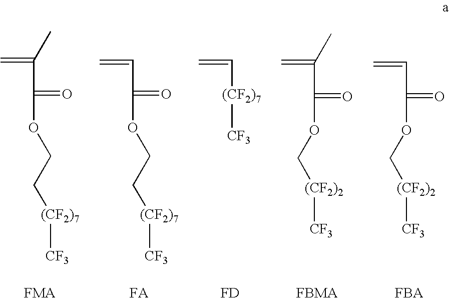

The particle size of each colloidal dispersion range from 94 to 105 nm with mono-modal distribution of the particles regardless of the F-monomer utilized.

Transmission electron micrographs (TEM) were acquired on a Zeiss EM 109T microscope using an accelerating voltage of 80 kV. Samples of colloidal dispersion used for TEM analysis were prepared by making a 1:10,000 dilution in deionized water followed by casting onto Formvar coated copper grids (Ted Pella, Inc.).

In an effort to identify particle morphologies, TEM images were collected of MMA/nBA (A), MMA/nBA/FMA (B), MMA/nBA/FA (C), MMA/nBA/FD (D), MMA/nBA/FBMA (E), and MMA/nBA/FBA (F). MMA/nBA colloidal particles exist as mono-modal entities with no considerable electron density changes, indicating a random copolymerization process. On the other hand, the presence of the long perfluoroalkyl side chains results in intra-particle phase separation with highly electron dense regions existing near the exterior of the particles. These data also show that by decreasing the length of the perfluoroalkyl side chain, the size of the phase-separated entities within a particle decreases. These findings confirm that an appropriate FSP/SDS surfactant combination facilitates the copolymerization of MMA/nBA/F-containing colloidal particles, and that F-monomer polymerizes as a blocky, phase-separated entity onto the exterior of existing p-MMA/nBA colloidal particles. The latter was also confirmed by NMR measurements.

### EXAMPLE 4

As stated in the Example 3, each colloidal dispersion is capable of forming a stable colloidal film, but the question is how the presence of F-monomer copolymerized into MMA/nBA affects film properties as compared to MMA/nBA. We utilized DMA to obtain the storage modulus at temperatures below the T_{g}. The storage modulus of MMA/nBA is 615 MPa, whereas incorporation of 8.5% (w/w) FMA into MMA/nBA colloidal systems results in its increase to 850 MPa. This behavior is attributed to the rigid nature of the F-containing monomer. Copolymerization of FA, FD, FBA, and FBMA into MMA/nBA colloidal particles also results in increased storage modules ranging from 720 to 900 MPa.

Thermal transitions were recorded using a TA Q800 dynamic mechanical analyzer (DMA) by heating the samples from −90° C. to 200° C. at a rate of 2° C./min and at a frequency of 1 Hz. Atomic force microscopy phase images (Nanoscope IIIa Dimension 3000 Scanning Probe Microscope, Digital Instruments) were obtained using a Si cantilever at a resonance frequency around 300 kHz.

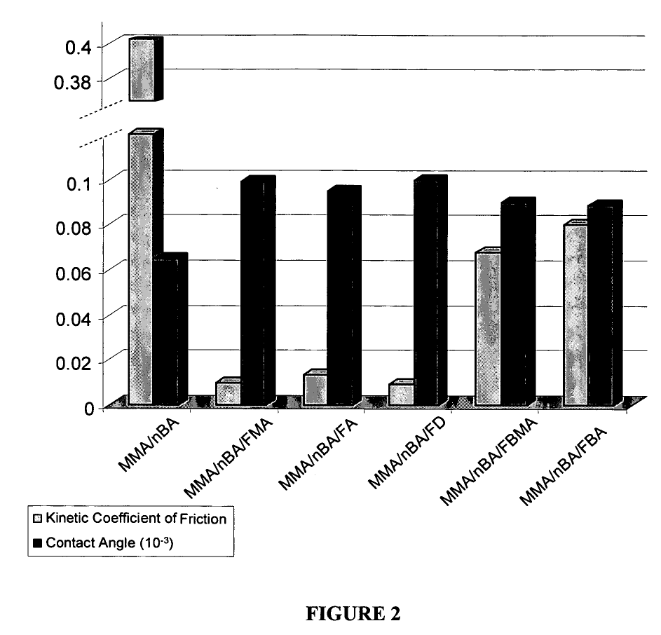

With these data in mind, it is of interest to elucidate how these differences affect surface macroscopic properties. For that purpose, we measured surface tension changes as well as the kinetic coefficients of friction at the F-A interface as a function of F-monomer, and these results are depicted in FIG. 2. Surface tension measurements of polymeric films were obtained using a FTA200 Dynamic Contact Angle Analyzer, and a Qualitest 1055 friction tester was utilized to determine the kinetic coefficient of friction.

As seen in FIG. 2, the presence of each copolymerized F-monomer alters the contact angle of a drop of water at the surface for each film, which for MMA/nBA/FMA is 100° and for MMA/nBA, the contact angle is 69°. Similarly, MMA/nBA/FA and MMA/nBA/FD exhibit contact angles of 96 and 101, respectively. However, the contact angle for the shorter perfluoroalkyl side chained MMA/nBA/FBMA and MMA/nBA/FBA colloidal films decreases to about 90°. Although similar trends are observed for the kinetic coefficient of friction at the F-A interface, significantly lower values are observed for FMA, FA, and FD monomers. Similar to DMA experiments, longer perfluoroalkyl side chains produce surfaces with more polytetrafluoro ethylene-like properties.

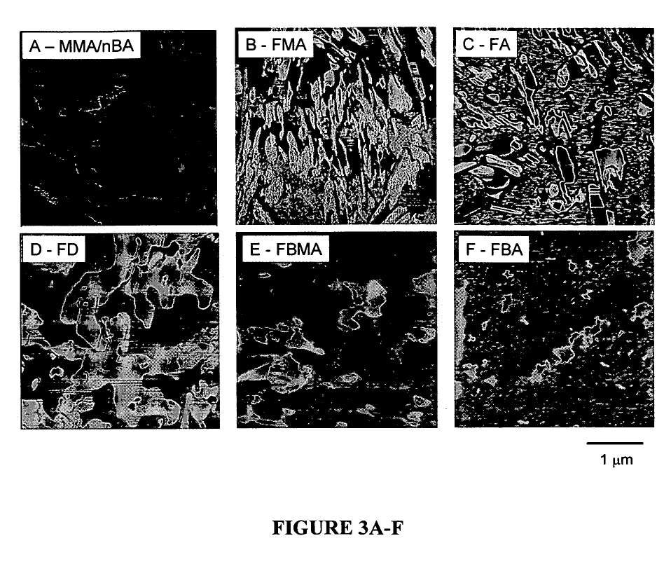

At this point, it is clear that the length of the CF₂ side chains affect both bulk and surface macroscopic measurements. The next question is what surface morphologies are responsible for these observed differences. FIG. 3 illustrates a series of AFM phase images recorded from the F-A interface for MMA/nBA (A), MMA/nBA/FMA (B), MMA/nBA/FA (C), MMA/nBA/FD (D), MMA/nBA/FBMA (E), and MMA/nBA/FBA (F). Each image represents a 5×5 μm sample area. As shown, Image A displays a continuous one phase component attributed to p-MMA/nBA at the F-A interface, whereas Image B (MMA/nBA/FMA) indicates the presence of high aspect ratio ordered entities at the F-A interface. Similar to previous studies, the presence of the crystallites results from directional stratification near the F-A interface. For comparison, Image C (MMA/nBA/FA) illustrates ordered domains of similar size and shape of FMA at the F-A interface, thus indicating similar surface properties between the —CF₂)₇—CF₃ side chains of the acrylic and methacrylic F-monomers. On the other hand, the presence of the non-acrylic, vinyl F-monomer with a similar —(CF₂)₇—CF₃ side chain results in surface morphologies with increased size of the crystalline or mesophase domains at the F-A interface (Image D). Images E and F illustrate AFM images of MMA/nBA/FBMA and MMA/nBA/FBA, respectively. As shown, there is a significant decrease of the size and surface coverage of the heterogeneous domains as compared to Images B-D, which is attributed to both FBMA and FBA possessing shorter perfluoroalkyl side chains (—(CF₂)₂—CF₃) subsequently leading to random aggregation with little to no crystalline components.

The chemicals disclosed herein are only representative of those suitable for this application. One of ordinary skill in the art would readily understand that a wide range of monomers can be polymerized, with one or more being a fluoro-monomer, using a surfactant system comprised of a fluoro-carbon containing phosphoric acid containing ester, anionic alkyl sulfate, and a suitable biologically active phospholipid. The specific examples listed herein are in no way meant to limit the scope of this invention.

### REFERENCES

(1) Chen, Y.; Ying, L.; Yu, j. W.; Kang, E.; Neoh, K. Macromolecules 2003, 36, 9451.

(2) Dargaville, T.; George, G.; Hill, D.; Whittacker, A. Macromolecules 2004, 37, 360.

(3) Deng, T.; Ha, Y.; Cheng, J.; Ross, C.; Thomas, E. Langmuir 2002, 18, 6719.

(4) Ding, L.; Olesik, S. Macromolecules 2003, 36, 4779.

(5) Fulton, J.; Deverman, G.; Yonker, C.; Grate, J.; De Yong, J.; McClain, J. Polymer 2004, 44, 3627.

(6) Gallyamoz, M.; Vinokur, R.; Nikitin, L.; Said-Galiyez, E.; Ernest, E.; Alexei, R.; Igor, V.; Schaumburg, K. Langmuir 2002, 18, 6928.

(7) Jin, J.; Smith, D.; Topping, C.; Suresh, S.; Chen, S.; Foulger, S.; Stephen, H.; Rice, N.; Nebo, J.; Mojazza, B. Macromolecules 2003, 36, 9000.

(8) Kang, S.; Luo, J.; Ma, H.; Barto, R.; Frank, C.; Dalton, L.; Jen, A. Macromolecules 2003, 36, 4355.

(9) Prabhakar, R.; Freeman, B.; Roman, I. Macromolecules 2004, 37, 7688.

(10) Sung, L.; Vicini, S.; Ho, D.; Hedhli, L.; Olmstead, C.; Kurt, W. Polymer 2004, 45, 6639.

(11) Borkar, S.; Siesler, H.; Hvilsted, S. Macromolecules 2004, 37, 788.

(12) Parker, H.; Lau, W.; Rosenlind, E. S.; Rohm and Haas Co, Pat. No. 6,218,464: USA, 2001.

(13) Banks, R. E.; Smart, B. E.; Tatlow, J. C. Organofluorine Chemistry Principles and Commercial Applications; Plenum Press: New York, 1994.

(14) Hiyama, T. Organofluorine Compounds; Springer-Verlag: Berlin, 2000.

(15) Lovell, P. A.; El-Aasser, M. S. Emulsion Polymerization and Emulsion Polymers; John Wiley & Sons: New York, 1997.

(16) LoNostro, P.; Choi, S.; Ku, C.; Chen, S. J. Phys. Chem. B 1999, 103, 5347.

(17) Movchan, T.; Plotnikova, E.; Redina, L.; Gal'braikh, L.; Ys'yarov, O. Colloid Journal 2003, 65, 47.

(18) Ha, J.; Park, I.; Lee, S.; Kim, D. Macromolecules 2002, 35, 6811.

(19) Cheng, S.; Chen, Y.; Chen, Z. J. Appl. Polym. Sci. 2002, 85, 1147.

(20) Barthelemy, P.; tomao, V.; Selb, J.; Chaudeir, Y.; Pucci, B. Langmuir 2002, 18, 2557.

(21) Kuwarnura, S.; Hibi, T.; Agawa, T. In Waterborne & High-solids, and Powder Coatings Symopsium: New Orleans, La., 1997; p 406.

(22) Kostov, G.; Ameduri, B.; Boutevin, B. J. Fluor. Chem. 2002, 114, 171.

(23) Huang, Z.; Shi, C.; Xu, J.; Kilic, S.; Enick, R.; Beckman, E. Macromolecules 2000, 33, 5437.

(24) Linemann, R. F.; Malner, T. E.; Brandsch, R.; Bar, G.; Ritter, W.; Mulhaupt, R. Macromolecules 1999, 32, 1715.

(25) Landfester, K.; Rothe, R.; Antonietti, M. Macromolecules 2002, 35, 1658.

(26) Fasick, R.; Raynolds, S.; E.I. DuPont de Nemours and Co, Pat. No. 3,282,905: USA, 1966.

(27) Fasick, R.; Johnson, R.; E.I. DuPont de Nemors Co, Pat. No. 3,378,609: USA, 1968.

(28) Raynolds, S.; Tandy, T.; E.I. DuPont de Nemours Co, Pat. No. 3,462,296, 1969.

(29) Kato, M.; Hiraharu, T.; Nishiwaki, K.; Tadenuma, H.; Japan Synthetic Rubber, Co., Pat. No. 5,349,003: USA, 1994.

(30) Kim, C. U.; Lee, J. M.; Ihm, S. K. J. Appl. Polym. Sci. 1999, 73, 777.

(31) Tsuda, N.; Iwakiri, Y.; Imoto, K.; Shimizu, Y.; Araki, T.; Kondo, M.; Daiken Industries, Ltd., Pat. No. 5,804,650: USA, 1998.

(32) Yamana, M.; Uesugi, N.; Ogura, E.; Daikin Industries, Ltd, Pat. No. 6,126,846: USA, 2000.

(33) Munekata, S. Prog in Org Coat 1988, 16, 113.

(34) Marion, P.; Beinert, G.; Juhue, D.; Lang, J. J. Appl. Polym. Sci. 1997, 64, 2409.

(35) Marion, P.; Beinert, G.; Juhue, D.; Lang, J. Macromolecules 1997, 30, 123.

(36) Thomas, R. R.; Lloyd, K. G.; Stika, L. M.; Stephans, L. E.; Magallanes, G. S.; Dimonie, V. L.; Sudol, E. D.; El-Aasser, M. S. Macromolecules 2000, 33, 8828.

(37) Adamson, A. W. Physical Chemistry of Surfaces, 2nd ed.; John Wiley & Sons, Inc., 1967.

(38) Wu, S. Polymer Interface and Adhesion; Marcel Dekker, Inc.: New York, 1982.

(39) Urban, M. W. Attenuated Total Reflectance Spectroscopy ofpolymers Theory and Practice; American Chemical Society, 1996.

(40) Urban, M. W. Encylcopedia ofAnalytical Chemistry; John Wiley & Sons, Ltd, 2000.

(41) Schaefer, J. S., E. O. Buchdahl, R. Macromolecules 1977, 10, 384-405.

(42) 1894-01, A. S. D.

(43) 5402-93, A. S. D.

(44) Liu, S. F.; Schmidt-Rohr, K. Macromolecules 2001, 34, 8416.

(45) Urban, M. W.; Provder, T. Multidimensional Spectroscopy ofpolymers; American Chemical Society: Washington D.C., 1995.

(46) Odian, G. Principles of Polymerization, 3rd ed.; John Wiley & Sons, Inc.: New York, 1991.

(47) Brandrup, J.; Immergut, E. H. Polymer Handbook, 2 ed.; John Wiley & Sons, Inc: USA, 1975.

(48) Dreher, W. R.; Zhang, P.; Urban, M. W.; Porzio, R. S.; Zhao, C. Macromolecules 2003, 36, 1228.

(49) Eastoe, J.; Rankin, A.; Wat, R.; Bain, C.; Styrkas, D.; Penfold, J. Langmuir 2003, 19, 7734.

(50) Dreher, W. R.; Urban, M. Langmuir 2004, In Press.

(51) Shafrin, E.; Zisman, W. J. Phys. Chem. 1962, 66, 740.

What is claimed is:

1. A process for forming fluorine-containing water-dispersible latexes comprising:
adding a fluoro-monomer and a co-monomer to a solution containing a surfactant component comprising a fluorinated surfactant; and
polymerizing the monomers.

2. The process for forming fluorine-containing water-dispersible latexes as defined in claim 1 wherein the co-monomer is an acrylate or methacrylate.

3. The process for forming fluorine-containing water-dispersible latexes as defined in claim 1 wherein the co-monomer is n-butyl acrylate or methyl methacrylate.

4. The process for forming fluorine-containing water-dispersible latexes as defined in claim 1 wherein the co-monomer comprises n-butyl acrylate and methyl methacrylate.

5. The process for forming fluorine-containing water-dispersible latexes as defined in claim 1 wherein the fluoro-monomer is selected from the group consisting of heptadecafluorodecyl methacrylate, heptadecafluorodecyl acrylate, heptadecafluoro-1-decene, heptafluorobutyl acrylate and heptafluorobutyl methacrylate.

6. The process for forming fluorine-containing water-dispersible latexes as defined in claim 1 wherein the fluorinated surfactant is a fluorocarbon containing phosphoric acid ester salt.

7. The process for forming fluorine-containing water-dispersible latexes as defined in claim 6 wherein the fluorinated surfactant is phosphoric acid bis(tridecafluoro-octyl) ester ammonium salt (FSP).

8. The process for forming fluorine-containing water-dispersible latexes as defined in claim 1 wherein the surfactant component further comprises an anionic surfactant.

9. The process for forming fluorine-containing water-dispersible latexes as defined in claim 8 wherein the anionic surfactant is sodium dodecyl sulfate.

10. The process for forming fluorine-containing water-dispersible latexes as defined in claim 1 wherein the surfactant component further comprises a phospholipid dispersing agent.

11. A water dispersible colloidal particle comprising two distinct polymeric phases, wherein polyacrylate or polymethacrylate form spherical particles and a non-spherical fluoro-polymer forms on the exterior of the spherical particles.

12. The water dispersible colloidal particle of claim 11, wherein the spherical particle comprises a polyacrylate/polymethacrylate co-polymer.

13. The water dispersible colloidal particle of claim 11, wherein the non-spherical fluoro-polymer is formed from a fluoro-monomer selected from the group consisting of heptadecafluorodecyl methacrylate, heptadecafluorodecyl acrylate, heptadecafluoro-1-decene, heptafluorobutyl acrylate and heptafluorobutyl methacrylate.

14. The water dispersible colloidal particle of claim 11, wherein the fluoro-polymer comprises from 5 to 20% (w/w) of the colloidal particle.

15. A water dispersible colloidal particle formed by the process of claim 1.
